(19) United States
(12) Patent Application Publication
(10) Pub. No.: US 2019/0152777 A1
(43) Pub. Date: May 23, 2019

(54) A METHOD FOR THE REDUCTION OF METHANOL EMISSION FROM AN AMMONIA PLANT

(71) Applicant: Haldor Topsøe A/S, Kgs. Lyngby (DK)

(72) Inventors: Christian Henrik Speth, Lynge (DK); Annette E. Krøll Jensen, Fredensborg (DK)

(73) Assignee: Haldor Topsoe A/S, Kgs. Lyngby (DK)

(21) Appl. No.: 16/300,330

(22) PCT Filed: Jun. 14, 2017
(86) PCT No.: PCT/EP2017/064515

§ 371 Date: Nov. 9, 2018

(30) Foreign Application Priority Data
Jun. 21, 2016 (PA) PA 2016 00367

(51) Int. Cl. C01B 3/02; B01D 53/14

(52) U.S. Cl. CPC C01B 3/025; C01C 1/0405; B01D 53/1493

(57) ABSTRACT

In a method for the reduction of methanol emission from an ammonia plant, a chilled methanol-containing feed gas is fed to a methanol absorber, carbon dioxide is separated from the gas phase leaving the methanol absorber, the methanol-containing gas is fed to a final separator, and the chilled, methanol-free process condensate from the final separator is used to wash out the methanol in a scrubbing column. By cooling the streams to the column and inserting a number of individual wash trays in the column, a practically quantitative removal of methanol is possible.

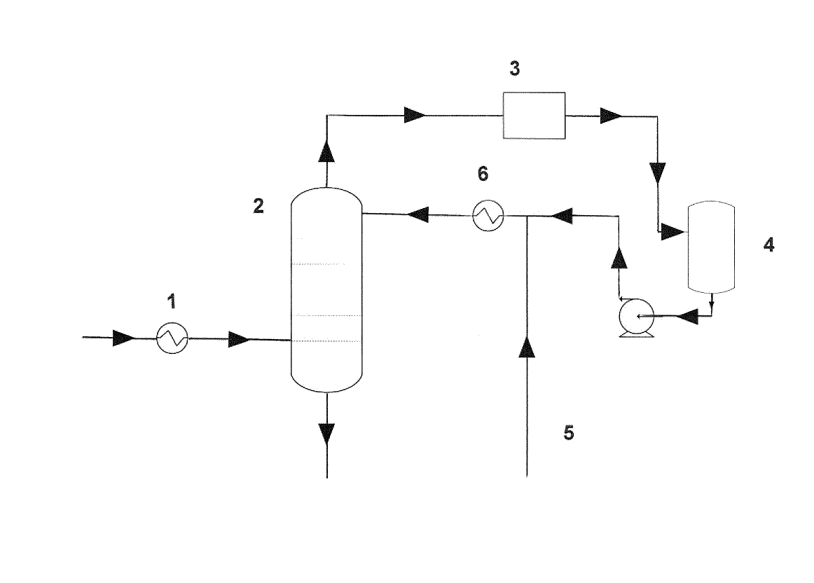

The present invention relates to a method for the reduction of methanol emission from an ammonia plant.

The catalytic synthesis of ammonia from hydrogen and nitrogen according to the equation

N₂+3H₂<->2NH₃ (ΔH=−92.4 kJ/mol)

was developed around 1908 and improved to industrial scale a few years later. Since then, this method (the Haber-Bosch method) has been the predominant industrial scale method for ammonia production. The synthesis is carried out in a circulatory system commonly known as an ammonia synthesis loop. Only a fraction of the synthesis gas is converted per pass, as limited by the equilibrium concentration of NH₃ at the exit conditions of the converter. A reactor design for ammonia production comprises at least one ammonia converter containing an ammonia synthesis catalyst.

The low temperature shift section in an ammonia plant produces mainly methanol as by-product. This problem is aggravated if the S/C (steam/carbon) ratio is decreased. In recent years, there has—for economic reasons—been a tendency in the industry to attempt to reduce the steam/carbon ratio.

The methanol formed as by-product will partly end up in the process condensate and partly end up in the CO₂ stream. The methanol in the condensate will be stripped off in the process condensate system and recycled to the reforming section. Thus, the methanol in the condensate does not constitute a problem, but the methanol content of the CO₂-rich gas is a problem because it will end up as an emission from the plant. Regulations concerning volatile organic compounds (VOCs) are continuously getting stricter, making it even more important to reduce methanol emissions from ammonia plants as much as possible.

Ammonia catalysts with a reduced activity for methanol production are currently being developed, but so far they are unable to reduce the methanol formation sufficiently to fully meet the specifications.

EP 0 294 564 A1 discloses a process for reducing the ammonia and methanol emission from an ammonia synthesis plant by stripping of the condensates containing the ammonia and methanol in dissolved form. The process is intended to provide a solution allowing reduction of the ammonia/methanol emission, where the energy used is optimized through the use of comparatively simple types of apparatus.

According to EP 0 979 858 A2, methanol emissions in the CO₂ vent from a synthesis gas unit in an ammonia or hydrogen plant are reduced by contacting raw synthesis gas from a low temperature shift converter with recycled stripped condensate to absorb methanol. The synthesis gas is treated in a purification unit to form a CO₂ vent of reduced methanol content.

U.S. Pat. No. 4,464,228 A describes a method of stripping volatile contaminants from an ammonia plant process condensate, recovering a stripped product condensate and using said condensate as a high quality makeup water for operating units within the ammonia process.

The present invention has been focused on developing an inexpensive way of removing or at least reducing the amount of methanol going to the CO₂ section of the ammonia plant. More specifically, the idea underlying the invention is to cool down the methanol-containing gas and subsequently use a chilled, methanol-free process condensate from the final separator (possibly supplemented by small amounts of a stripped, regenerated process condensate) to wash out the methanol in the synthesis gas by installing a small scrubbing column in place of the original process condensate separator downstream the shift section and upstream the CO₂ wash.

In a first aspect of the present invention, an inexpensive way to remove or reduce the methanol going to the CO₂ section is provided.

In a second aspect of the present invention is provided a way to help the possibility of running a front end with a reduced S/C ratio.

These and other advantages are provided by a method for the reduction of methanol emission from an ammonia plant, wherein
the methanol-containing feed gas is chilled and fed to a methanol absorber,
a cooled, methanol-free aqueous stream is used to absorb the methanol in the feed stream,
the methanol-lean gas is leaving the methanol absorber in the top and routed to downstream processing, preferably a CO₂ removal, and
the methanol-rich aqueous stream is leaving the methanol absorber in the bottom and routed to further processing elsewhere in the plant.

The methanol-containing feed gas, which is to be treated by the method of the invention, comes from the shift section of an ammonia plant. As mentioned, it is a gas rich in CO₂ which, if not treated, will end up as an emission from the plant. During the shift process, CO+H₂O will be converted to CO₂+H₂, so the cooled feed gas to be treated consists primarily of CO₂ and H₂ but also methanol and traces of CO and water.

In accordance with the above method, the CO₂-free gas from the CO₂ removal is passed through a final separator to obtain a methanol-free process condensate. This methanol-free process condensate is cooled and then used to wash out the methanol in the methanol absorber.

In the methanol absorber, methanol is removed from the gas as a condensate, which is subsequently stripped of methanol in a process condensate stripper. The gas phase is fed to CO₂ removal and then to a final separator, in which water is separated off and—after cooling—used as wash water in the methanol absorber.

A small amount of a cooled, regenerated process condensate is preferably added to the cooled, methanol-free process condensate from the final separator before washing out the methanol.

In the method according to the invention, the streams are preferably cooled down to a suitable low temperature for the absorption of methanol, and a number of wash trays are inserted in the methanol absorber.

The attached FIGURE shows a possible equipment design for the reduction of methanol emission from an ammonia plant by the method of the invention, said design comprising a feed gas chiller (1), which provides the necessary cooling of the methanol-containing feed gas. The cooled gas is passed to a methanol absorber (2), where methanol is separated off. Then the gas phase from the methanol absorber is fed to a carbon dioxide removal section (3), and the CO₂-free gas is passed to a final separator (4), thereby obtaining a methanol-free process condensate. This process condensate is mixed with a stripped process condensate (5) and passed to the methanol absorber (2) via a wash water chiller (6).

Calculations have shown that, even in the worst case, a practically quantitative removal of methanol is possible if the streams to the column are cooled down to around 5° C. and ten wash trays are inserted in the column. If a catalyst with an ability to inhibit by-product formation is used and/or the environmental restrictions are less strict, the number of wash trays in the column can be reduced.

1. A method for the reduction of methanol emission from an ammonia plant, wherein
the methanol-containing feed gas is cooled and fed into a methanol absorber,
a cooled, methanol-free aqueous stream is used to absorb the methanol in the feed stream,
the methanol-lean gas is leaving the methanol absorber in the top and routed to downstream processing, preferably a CO₂ removal, and
the methanol-rich aqueous stream is leaving the methanol absorber in the bottom and routed to further processing elsewhere in the plant.

2. Method according to claim 1, wherein the CO₂-free gas from the CO₂ removal is passed through a final separator to obtain a methanol-free process condensate.

3. Method according to claim 2, wherein the methanol-free process condensate is cooled and then used to wash out the methanol in the methanol absorber.

4. Method according to claim 3, wherein a small amount of a cooled, regenerated process condensate is added to the cooled, methanol-free process condensate from the final separator before washing out the methanol.

5. Method according to claim 1, wherein the streams are cooled down to a suitable low temperature for the absorption of methanol and a number of wash trays are inserted in the methanol absorber.
